(19) United States
(12) Patent Application Publication
(10) Pub. No.: US 2006/0139370 A1
(43) Pub. Date: Jun. 29, 2006

(54) Strong wave

(76) Inventor: Antonio Fernando Melo e Silva, Lousado (PT)

Correspondence Address: Antonio Fernando;Melo e Silva, Rua da Circulacao, 150, V.N. Famalicao, 4760-621, PT

(21) Appl. No.: 11/023,864

(22) Filed: Dec. 29, 2004

(51) Int. Cl. G09G 5/00

(52) U.S. Cl. 345/619

(57) ABSTRACT

My invention “STRONG WAVE” is a design of a geometric figure, this figure can be used itself or combined with itself (two or more combinations), in the same size or different sizes, in a lot of different positions; resulting in graphic symbols, patterns, logos and others new designs.

### CROSS REFERENCE TO RELATED APPLICATIONS

“STRONG WAVE”, has many applications, when combined with two or more “STRONG WAVE” with the same size or different sizes, in the same harmony (proportion sizes), will result in patterns, graphic symbols, logos and other things, which can be used in textiles, publicity, ceramics and other industries.

### BACKGROUND OF THE INVENTION

“STRONG WAVE” is a geometric figure, created from a computer programme, belonging to the Class 345-Computer Graphics Processing, and the Subject Matter for this invention is a Utility Patent, which is more adequate.

The invention “STRONG WAVE” was emerged in 2003 in the programme Paint of Mac OS 8.6 and I have requested for registered with OHMI (OFFICE FOR HARMONIZATION THE INTERNAL MARKET) in Jan. 8, 2004 and was publicist in Apr. 6, 2004 in newspaper of designs and community models number 2004/030 with register n° 000124664\0002. I registered too, a letters font and nineteen patterns created with “STRONG WAVE”, this registry was publicist in Dec. 14, 2004 with the reference n°-000240478-0001 to 0020.

### BRIEF SUMMARY OF THE INVENTION

“STRONG WAVE” is a geometric figure, which could be used by itself or combined with itself in a lot of positions, to create new designs.

### BRIEF DESCRIPTION OF THE DRAWINGS

I have drawn five figures to confirm the applications of my invention:

FIG. 1.1 is a “STRONG WAVE” only, in two different sizes.

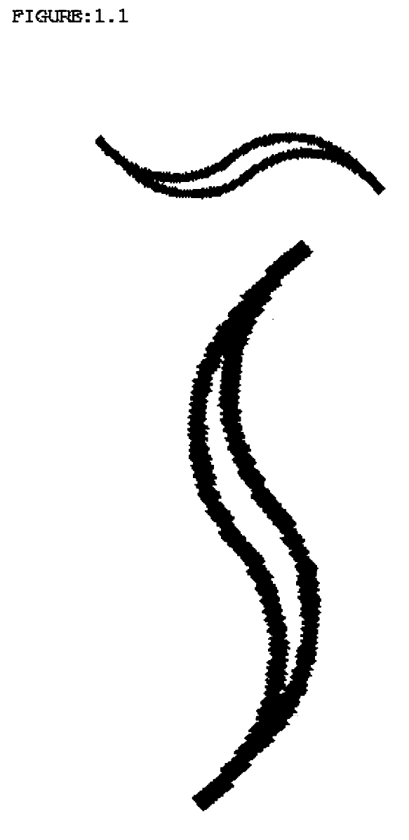

FIG. 1.2 is a pattern, which employs “STONG WAVE” combined itself, with the same sizes.

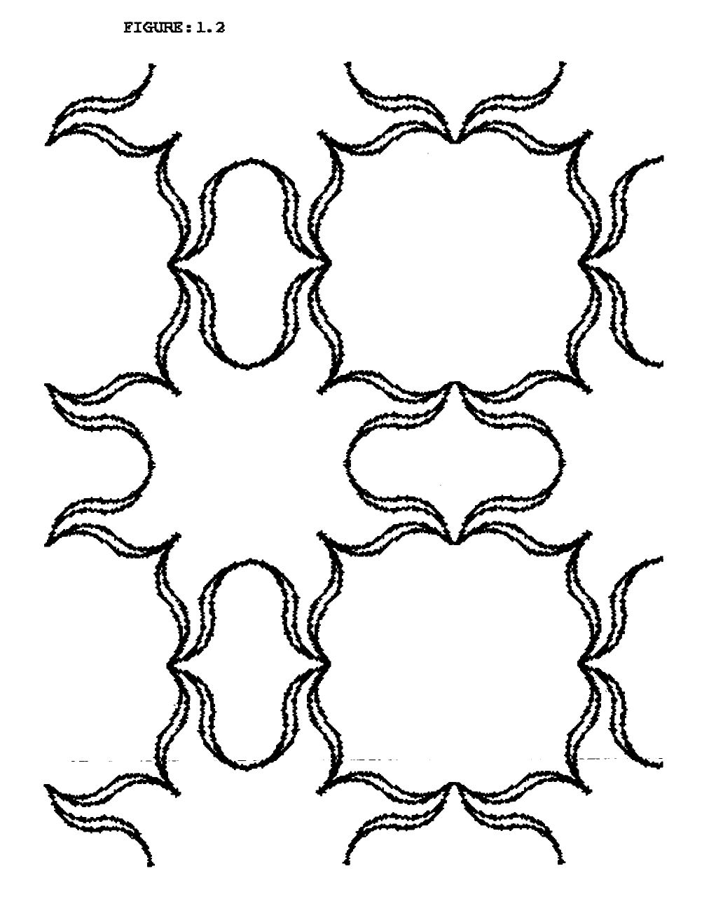

FIG. 1.3 is a pattern, which employs “STRONG WAVE” combined itself, with a different sizes.

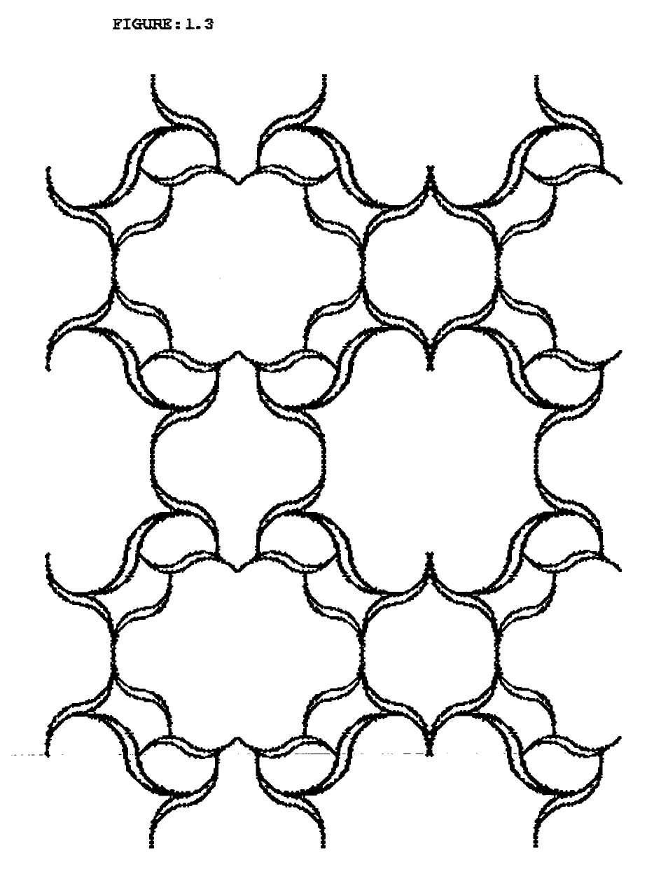

FIG. 1.4 is a pattern, which employs “STRONG WAVE” combined itself, with a different sizes.

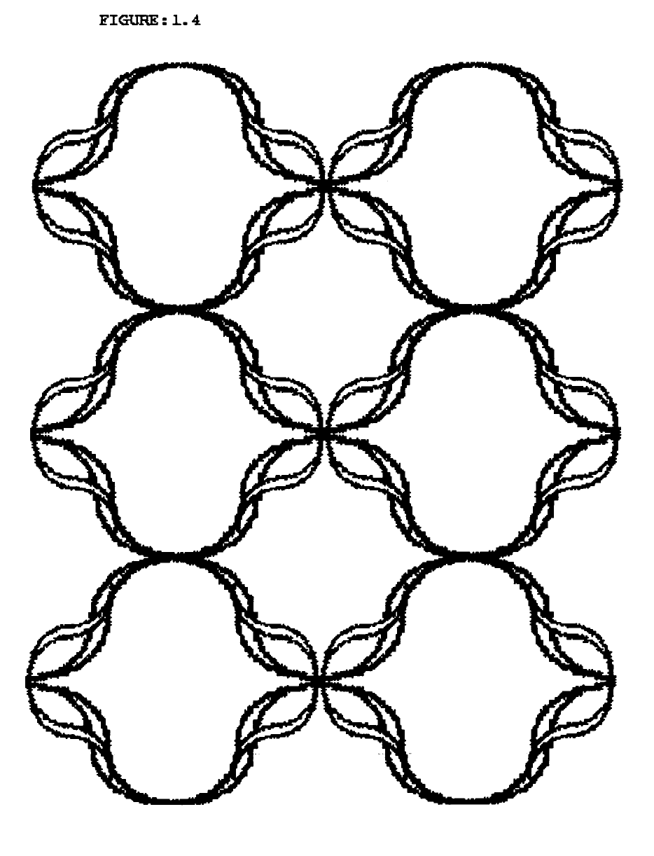

FIG. 1.5 is a letter font, which employs “STRONG WAVE” combined itself.

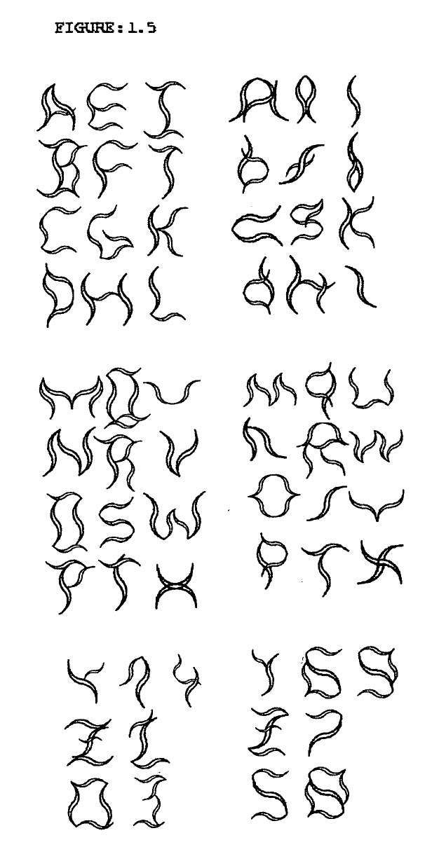

### DETAILED DESCRIPTION

“STRONG WAVE” is a geometric figure, with two lines sinusoidal; the lines intersect on the initial point and intersect also in the closure. The figure is billed on the two extremities.

1. I claim a Utility Patent for my invention “STRONG WAVE”, under the CLASS 345-COMPUTER GRAPHICS PROCESSING, protected by the Subclass 619-Graphic manipulation.

2. I claim a Utility Patent for my invention “STRONG WAVE” under the CLASS 345-COMPUTER GRAFHICS PROCESSING, protected by the Subclass 629-Merge or Overlay.

3. I claim a Utility Patent for my invention “STRONG WAVE”, under the CLASS 345-COMPUTER GRAPHICS PROCESSING, protected by the Subclass 630-Combining Model Representation.

4. I claim a Utility Patent for my invention “STRONG WAVE”, under the CLASS 345-COMPUTER GRAPHICS PROCESING, protected by the Subclass 634-Image based.

5. I claim a Utility Patent for my invention “STRONG WAVE”, under the CLASS 345-COMPUTER GRAPHICS PROCESSING, protected by the Subclass 636-Character and Graphics.

6. I claim a Utility Patent for my invention “STRONG WAVE”, under the CLASS 345-COMPUTER GRAPHICS PROCESSING, protected by the Subclass 649-Rotation.

7. I claim a Utility Patent for my invention “STRONG WAVE”, under the CLASS 345-COMPUTER GRAPHICS PROCESSING, protected by the Subclass 650-Graphical user interface tools.

8. I claim a Utility Patent for my invention “STRONG WAVE”, under the CLASS 345-COMPUTER GRAPHICS PROCESSING, protected by the Subclass 685-Alphanumeric.
